(19) United States
(12) Patent Application Publication
(10) Pub. No.: US 2010/0252071 A1
(43) Pub. Date: Oct. 7, 2010

(54) Method and tool for unclogging toilet drains

(76) Inventor: Kevin B. Bounds, Virgina Beach, VA (US)

Correspondence Address: DUANE MORRIS LLP - DC, 505 9th Street, Suite 1000, WASHINGTON, DC, 20004-2166, US

(21) Appl. No.: 12/385,242

(22) Filed: Apr. 2, 2009

(51) Int. Cl. E03D 9/00; B08B 7/00

(52) U.S. Cl. 134/6; 4/255.01

(57) ABSTRACT

Disclosed are methods of unclogging toilet drains using a novel dissolvable paper tool to dislodged a blocking impediment in the clogged drain.

### BACKGROUND OF THE INVENTION

1. Field of the Invention

This invention relates to a method of unclogging toilet drains using a dissolvable paper tool to dislodged a blocking impediment in a clogged drain.

2. Description of Related Art

At some point in everyone's life, a person experiences the displeasure of encountering a clogged toilet drain wherein an impediment blocks the toilet drain, such that the water of a toilet bowl does not drain properly. This problem has become more common with the advent of low-flow or “green” toilets, which use less water per flush.

Under such circumstances, a person typically reaches for a common household plunger or auger to try to unclog the toilet drain.

There are many disadvantages associated with using conventional household tools such as plungers and augers in such situations. The primary disadvantage associated with using a household plunger is that the plunger or auger becomes soiled and germ-laden when used in a clogged toilet. When removed from the toilet after use, the filth and germs on the plunger or auger may be transferred to other household surfaces.

Therefore, there is a need for a disposable apparatus for unblocking a toilet drain wherein the apparatus can be easily disposed of after use without having to be removed from the toilet. This will substantially, if not completely, reduce the opportunity for potentially infectious agents to be spread to others surfaces.

Another disadvantage with conventional household plungers is that it attempts to create a vacuum within the toilet drain, with a manual pumping action being used to create a suction. The blocking impediment in the toilet drain is then pushed and pulled via this suction, until it is loosened and eventually flushed away. This suction, however, increases the possibility that filthy water from the toilet may splash onto external surfaces and/or the individual seeking to unblock the drain.

Moreover, in some cases, the impediment is not removed in a timely manner due to the bulky size and/or nature of the impediment. In such instances, what is needed is an apparatus for unclogging a toilet drain that can facilitate breaking up the impediment and thereby making it easier to flush down the toilet drain.

In addition to a conventional household plunger, a number of different devices have been proposed for assisting a person with unclogging a toilet drain. However, none of these available apparatuses are designed for household use wherein the apparatus is clean, effective, easy to use and, perhaps most importantly, easily disposable.

For example, U.S. Pat. No. 963,965 to Weber discloses a pipe cleaner comprising a gripping member which grabs the blocking impediment so that it can be pulled from the toilet drain. Due to the complicated mechanical nature of this apparatus, the disclosed pipe cleaner requires a certain amount of skill and proficiency in inserting the pipe cleaner and working the gripping member. In addition, this device involves removing the blocking impediment from the toilet altogether, thereby ensuring that soiled, germ-laden water is spread to other household surfaces.

Similarly, U.S. Pat. No. 1,261,444 to Schied discloses a tool for removing obstructions from plumbing passageways which comprises a grappling member having a plurality of twisted pronged tines attached to the end of an elongated shaft and crank handle. In use, the tool is inserted into a clogged toilet drain until an impediment is contacted. If the impediment cannot be pushed through the toilet drain, the user turns the crank thereby turning the grappling member until the tines embed the impediment such that it can be pulled from the toilet drain.

A significant problem with these older devices is that they require the user to remove the blocking impediment must be pulled from the toilet drain. In such instances, the user then has to dispose of the blocking impediment as well as worry about the soiled device.

Alternatively, U.S. Pat. No. 2,567,923 to Burke discloses a pip-cleaning swab that comprises an elongated shaft with a bent plate attached to one end of the elongated shaft and having a textile sleeve with tentacles covering the bent plate. This device is used to push the blocking impediment through the drain. This device, however, is not disposable and therefore must be cleaned after use to reduce the spread of soiled water to household surfaces.

More recently, U.S. Pat. No. 5,862,834 discloses a drain pipe obstruction clearing tool comprising an exterior cylinder having a plunger like head, a closed upper end with an aperture therein sliding and sealing engagement with a reciprocating handle shaft. This device, however, is not disposable and must also be cleaned after use.

Similarly, U.S. Pat. No. 7,194,773 discloses a bladed tool for chopping, churning and agitating a blocking impediment so that it can be flushed down the toilet. Again, however, this device is not disposable and must be cleaned after use.

Therefore, there has been a need for a disposable tool for clearing a blocking impediment from a drain, such as a toilet drain, which does not need to be removed from the toilet after use.

In this regard, U.S. Pat. No. 6,179,928 discloses a disposable apparatus having a handle and a plurality of elongated loops connected to the handle provides a means for unclogging a toilet or sink drain of an impediment. Although disposable, this device must still be removed from the toilet and discarded into a trash can or other suitable receptacle. As such, there remains the possibility of soiled water being spread to household surfaces.

U.S. Pat. No. 7,124,450 discloses a flushable toilet plunger cover to minimize the possibility of splashing during attempts to remove a blocking impediment. Although disposable and flushable, this concept still involves the use of a conventional household plunger and all the problems associated therewith.

There therefore remains a need in the art for a disposable tool for removing a blocking impediment from a drain that does not need to be removed from the site after use.

### SUMMARY OF THE INVENTION

It is therefore an object of the present invention to overcome the deficiencies associated with known tools for clearing a blocking impediment from a drain, particularly a toilet drain. It is further an object of the present invention to provide methods and tools for clearing a blocking impediment from a drain, particularly a toilet drain, which substantially reduce the possibility of spreading germs or filth from dirty water, such as used toilet water, to household surfaces and/or to the user.

The present invention solves the problems associated with prior designs for removing impediments from a clogged toilet drain by providing a novel tool for clearing blocking impediments from a drain. The tool of the present invention is comprised of a dissolvable paper, such that, after use, the tool may simply be dropped into the toilet or sink and then flushed or washed away down the drain.

There are many advantages associated with the dissolvable paper tool of the present invention. First, the dissolvable paper tool of the present invention is dimensioned such that a suitable force can be applied to a blocking impediment in the drain without the user's hand coming into contact with the water or any other surface.

In addition, the dissolvable paper tool is very simple and easy to use. A person does not have to deal with any complicated mechanical devices or methods of operation. That is, in use, a person merely has to insert the dissolvable paper tool into the toilet drain until a blocking impediment is contacted, push and twist the dissolvable paper tool until the impediment is sufficiently dislodged and/or broken up, then drop the dissolvable paper tool into the sink or toilet, and, finally, flush or wash the impediment and any remnants of the dissolvable paper tool down the drain.

The dissolvable paper tool of the present invention is also very economical. Due to its simple design and structure, the dissolvable paper tool is very inexpensive and intended to be disposable. After use, a user does not have to clean the dissolvable paper tool or worry about storing the dissolvable paper tool—the user can simply drop the dissolvable paper tool into a the toilet or sink being unclogged and then flush or wash the remnants thereof down the unclogged drain.

The dissolvable paper tool of the present invention is also very hygienic. Because it is disposable, the dissolvable paper tool does not need to be cleaned or stored after use. Further, because it is made of dissolvable paper, the inventive tool does not need to be removed from the site of use, e.g. a clogged toilet, for disposal. This substantially, if not completely, reduces the possibility of germs being spread to nearby household surfaces.

Finally, the dissolvable paper tool of the present invention is not intended to replace common household plungers or augers in their entirety. Rather, as contemplated herein, the inventive dissolvable paper tool is intended to be a “first option” for an individual faced with a clogged toilet drain. Because it is completely dissolvable in any water present in a blocked toilet, if this “first option” is not altogether successful, a common household plunger or auger can then be used in a conventional manner as if no other attempt had even been made.

### DETAILED DESCRIPTION OF THE PREFERRED EMBODIMENTS

In accordance with these and other objects, a first preferred embodiment of the present invention is directed to a method of unclogging a drain containing at least one blocking impediment comprising applying external force to said blocking impediment using at least one rapidly dissolvable paper tool.

The rapidly dissolvable paper tool of the present invention has a first end and a second end and these ends are separated by a predetermined distance. In its simplest form, the rapidly dissolvable paper tool may be as basic as a paper tube or cylinder of suitable dimensions, as described below. The particular shape of the dissolvable paper tool is less important than its relative dimensions. Although it is preferred that the dissolvable paper tool have a substantially circular or elliptical cross-section, polygonal cross-sections are also contemplated.

The first end of the dissolvable paper tool is dimensioned to permit a user to securely hold the dissolvable paper tool during use. Suitable dimensions may be determined empirically, but, at least generally, the first end of the dissolvable paper tool is dimensioned such that it fits comfortable and securely in an adult human hand such that the tool can be manipulated in accordance with the methods of the present invention.

The second end of the dissolvable paper tool is dimensioned to fit easily within a standard drain. Such dimensions are known to those skilled in the art and may vary depending upon the particular application intended. Thus, for example, a dissolvable paper tool intended for use in a toilet may have differ in dimensions from a dissolvable paper tool intended for use in a urinal or water fountain.

The first end and the second end of the dissolvable paper tool are separated by a predetermined distance. This predetermined distance is sufficient for the user's hand to remain above the level of water while gripping the first end of the dissolvable paper tool and while the second end of dissolvable paper tool is in contact with at least one blocking impediment in the drain. Suitable predetermined distances may be determined empirically by one skilled in the art depending upon the ultimate application of the inventive dissolvable paper tool.

The dissolvable paper tool of the present invention maintains its form for a sufficient period of time to permit a user to try to dislodge at least one blocking impediment in a drain. As used herein, a “sufficient period of time” may be as short as five (5) seconds or as long as five (5) minutes. The only requirement is that it be long enough for a user to apply an external force to blocking impediment in a drain. Suitable periods of time may therefore be determined empirically by one skilled in art depending, for example, on the particular material(s) used to form the dissolvable paper tool.

Following use, the dissolvable paper tool then dissolves substantially completely within a predetermined period of time. As used herein, this “predetermined period of time” may be as short as a few seconds or as long as fifteen (15) minutes. Suitable periods of time may therefore be determined empirically by one skilled in art depending, for example, on the particular material(s) used to form the dissolvable paper tool.

The dissolvable paper tool of the present invention is preferably made from a water soluble paper. According to certain embodiments of the present invention, the dissolvable paper tool may be made from a single sheet of water soluble paper, which is rolled into a cylinder or tube of suitable dimensions. According to other embodiments of the present invention, the dissolvable paper tool may be made from a plurality of water soluble paper fibers, which are compressed or bound in a predetermined shape or form, such as a cylinder or tube. According to still other embodiments, the dissolvable paper tool may be made from a sheet of dissolvable paper which has been impregnated with fibers to increase, for example, the structural integrity and/or rigidity thereof. According to still other embodiments, a combination of different water soluble papers may be used.

Suitable water soluble papers are known and available to those skilled in the art. The choice of a particular water soluble paper, or combination thereof, may be made empirically by one skilled in the art. Suitable papers for making the inventive dissolvable paper tool are commercially available from Dissolvo LLC, Bowling Green, Ohio. and Custom Paper Tubes, Inc., Cleveland, Ohio.

According to certain embodiments of the present invention, the dissolvable paper tool optionally includes a handle. Such a handle is preferably made of the same material(s) as the dissolvable paper tool and can be disposed of in substantially the same manner. In its simplest form, such a handle may comprise a tube of water soluble paper dimensioned to fit securely over the first end of the inventive dissolvable paper tool.

While various embodiments of the present invention have been described above, it should be understood that they have been presented by the way of example only, and not limitation. It will be understood by those skilled in the art that various changes in form and details may be made therein without departing from the spirit and scope of the invention as defined in the specification and the appended claims. Thus, the breadth and scope of the present invention should not be limited by any of the above-described exemplary embodiments, but should be defined in accordance with the specification and any equivalents.

What is claimed is:

1. A method of unclogging a drain containing at least one blocking impediment comprising applying external force to said blocking impediment using at least one dissolvable paper tool having a first end and a second end separated by a predetermined distance,
wherein said dissolvable paper tool is dimensioned to permit a user to securely hold said first end of said elongated member above the level of water while said second end of said elongated member is in contact with at least one blocking impediment in said drain, and
wherein said dissolvable paper tool maintains its form for a sufficient period of time to permit a user to dislodge said at least one blocking impediment in said drain and then dissolves substantially completely within a predetermined period of time.

2. The method according to claim 1, wherein said dissolvable paper tool is substantially cylindrical in shape.

3. The method according to claim 1, wherein said dissolvable paper tool is substantially solid.

4. The method according to claim 1, wherein said dissolvable paper tool is substantially hollow.

5. The method according to claim 1, wherein said predetermined time is less than one (1) minute.

6. The method according to claim 1, wherein said sufficient period of time is at least five (5) seconds.

7. The method according to claim 1, wherein said dissolvable paper tool comprises at least one sheet of water soluble paper which has been rolled or formed into a substantially cylindrical shape.

8. The method according to claim 1, wherein said dissolvable paper tool comprises a plurality of water soluble fibers formed into a substantially cylindrical shape.

9. The method according to claim 1, wherein said dissolvable paper tool has a substantially circular cross-section.

10. The method according to claim 1, wherein said predetermined distance is between twelve (12) inches and eighteen (18) inches.

11. A dissolvable paper tool for use in removing a blocking impediment from a drain, said dissolvable paper tool having a first end and a second end separated by a predetermined distance,
wherein said dissolvable paper tool is dimensioned to permit a user to securely hold said first end of said elongated member above the level of water while said second end of said elongated member is in contact with at least one blocking impediment in said drain, and
wherein said dissolvable paper tool maintains its form for a sufficient period of time to permit a user to dislodge said at least one blocking impediment in said drain and then dissolves substantially completely within a predetermined period of time.
